(19) United States
(12) Patent Application Publication
(10) Pub. No.: US 2004/0001704 A1
(43) Pub. Date: Jan. 1, 2004

(54) Slide show with audio

(76) Inventors: Ming Hong Chan, San Jose, CA (US); Haisong Wang, Fremont, CA (US)

Correspondence Address: MILBANK, TWEED, HADLEY & MCCLOY LLP, 1 CHASE MANHATTAN PLAZA, NEW YORK, NY, 10005-1413, US

(21) Appl. No.: 10/185,248

(22) Filed: Jun. 27, 2002

(51) Int. Cl. H04N 5/781

(52) U.S. Cl. 386/96; 386/125

(57) ABSTRACT

The present invention relates to devices and methods for processing data defining a still image slide show with background audio. An example system may include an optical disk player (e.g., DVD player) configured to read video and audio data from one or more storage media (e.g., DVD, compact flash device and/or hard disk). An example method may include presenting output signals containing data descriptive of a slide show with background audio in a mode or configuration selected by a user.

### FIELD OF THE INVENTION

The present invention relates to slide show presentations, and more particularly, to devices and methods for presenting an electronic slide show with audio.

### BACKGROUND OF THE INVENTION

Video files and/or audio files may be stored in fixed and/or portable types of storage media. For example, a digital versatile disk (DVD) or other type of optical disk may store audio and video data that, when read by a DVD player, provides for a viewer an audio and visual presentation in the form of a motion picture with sound. Still pictures may be stored on certain types of optical disks (e.g., recordable compact disks (CD-R)), which may be read by a DVD player for display on a television. In certain instances, a viewer may obtain an optical disk containing video data formatted to automatically present a slide show of still pictures in a pre-determined sequence once the optical disk is inserted into a DVD player. In such instances, however, the viewer may not be able either to select the sequence of display of the still pictures stored on the optical disk, or to associate a sound file with the still pictures.

### SUMMARY OF THE INVENTION

In one aspect, the invention features an apparatus including a memory medium reader configured to read an audio data file and a video data file, wherein the audio data file contains data descriptive of an audio track and the video data file contains data descriptive of a still image. According to such an aspect, the apparatus further includes a processor circuit configured to decode the audio data file and the video data file, create in real time an association between the still image and the audio track, and generate a slide show comprising the still image and the audio track.

In another aspect, the invention features a digital versatile disk (DVD) player including an integrated circuit chip configured to generate a still image slide show with an audio track.

In yet another aspect, the invention features a method including decoding an audio data file and a video data file, wherein the audio data file contains data descriptive of an audio track and the video data file contains data descriptive of a still image. According to such an aspect, the method further includes creating in real time an association between the still image and the audio track, and generating a slide show including the still image and the audio track.

In a further aspect, the invention features a system including means for decoding an audio data file and a video data file, wherein the audio data file contains data descriptive of an audio track and the video data file contains data descriptive of a still image. According to such as aspect, the system further includes means for creating in real time an association between the still image and the audio track, and means for generating a slide show including the still image and the audio track.

### BRIEF DESCRIPTION OF THE DRAWINGS

The foregoing features and other aspects of the invention are explained in the following description taken in connection with the accompanying drawings, wherein:

FIG. 1 is a block diagram of an optical disk player 10 according to one embodiment of the present invention;

FIG. 2 is a block diagram of an integrated circuit processor chip 100 of the optical disk player 10 shown in FIG. 1;

FIG. 3 shows a front view of the optical disk player 10 shown in FIG. 1;

FIG. 4 shows a remote control device 15 for use with the optical disk player 10 shown in FIG. 1;

FIGS. 5a-5d illustrate one example of major steps performed by the processor chip 100 shown in FIG. 2 in presenting a still image slide show with sound;

FIG. 6 depicts an information screen 650, as displayed by a television 20, for use in configuring an electronic slide show presentation in accordance with an embodiment of the present invention; and

FIG. 7 illustrates one example of a video data and audio data reading, decoding and presenting sequence according to an embodiment of the present invention.

FIG. 8 illustrates another example of a video data and audio data reading, decoding and presenting sequence according to an embodiment of the present invention.

It is to be understood that the drawings are exemplary, and are not to be deemed limiting to the full scope of the appended claims.

### DETAILED DESCRIPTION OF PREFERRED EMBODIMENTS

Various embodiments of devices and systems in accordance with embodiments of the present invention will now be described with reference to the drawings.

I. Device and System Embodiments of the Invention

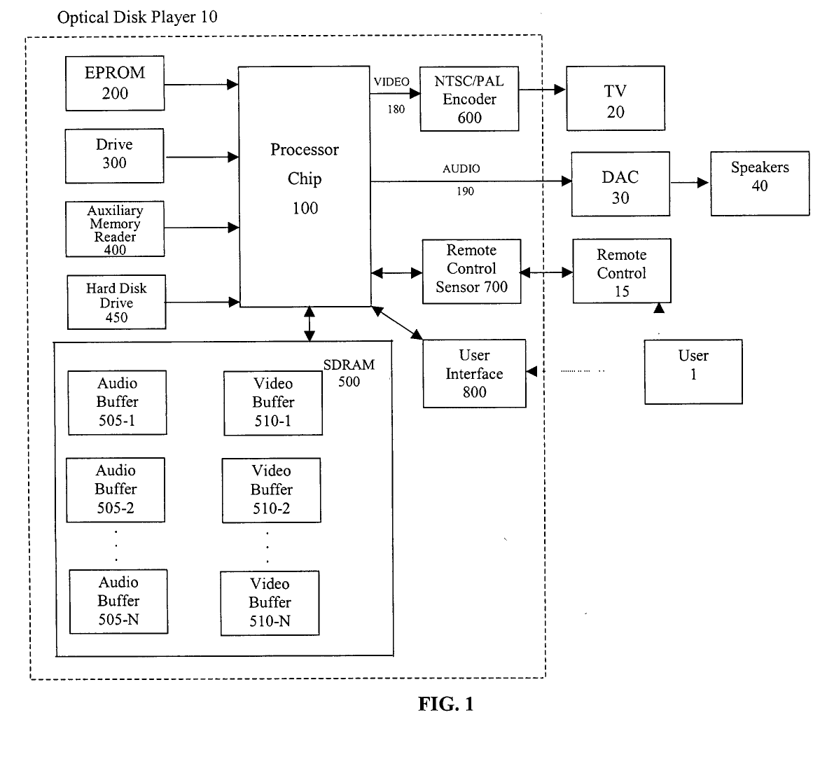

FIG. 1 depicts a multimedia system including an optical disk player 10 and its corresponding remote control device 15 according to one embodiment of the present invention. As shown, this multimedia system further includes a television (TV) 20, and an audio signal digital to analog converter (DAC) 30 (e.g., a stereo system or other audio amplifier) in turn connected to one or more speakers 40. The optical disk player 10 shown in FIG. 1 generally includes a processor chip 100, read-only memory (ROM) 200, a optical disk drive 300, an auxiliary memory reader 400, a hard disk drive (HDD) 450, a dynamic random access memory (DRAM) 500, a video signal encoder 600, a remote control sensor 700 and a user interface 800 (e.g., a keypad, a touch-pad or control buttons). The functions and/or structures of these components will now be explained in further detail.

In one embodiment, a processor chip 100 may provide a video output signal 180 and an audio output signal 190 based on input from a user 1 and data from the drive 300, auxiliary memory reader 400 and/or hard disk drive 450. The processor chip 100 of one embodiment may be able to decode a number of different audio data formats (including, for example, .mp3 file extensions, .wma file extensions, .wav file extensions, compact disc digital audio (CD-DA), Dolby® Digital (AC-3) and DTS® digital surround sound) simultaneously with a number of different video data formats (including, for example, bit-mapped graphics (.bmp file extensions), MPEG-1, MPEG-2 and JPEG). In connection with certain embodiments, still image video image data as well as audio data for use in an electronic slide show presentation may be obtained from one or more of a number of different types of fixed and/or portable memory devices. One example of a fixed memory medium may be a hard disk which is read by a hard disk drive. Examples of portable memory media may include various optical disks and flash memory devices.

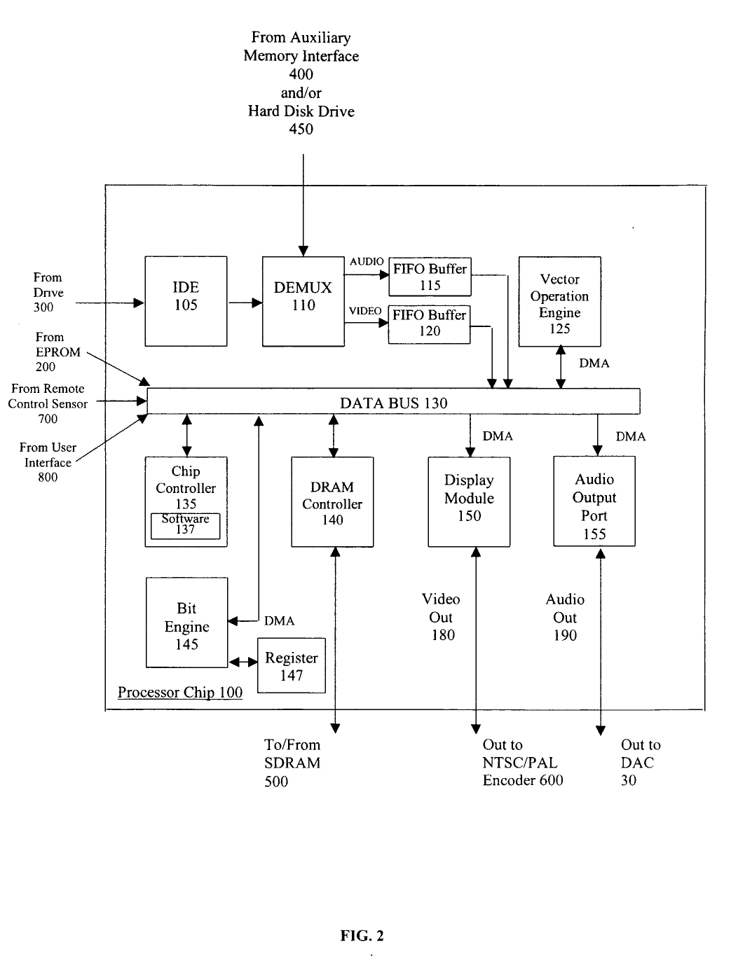

FIG. 2 depicts a block diagram of the internal structure of a processor chip 100 according to one embodiment of the present invention. Such a processor chip 100 may be packaged in a 208-pin plastic quad flat package (PQFP). As shown, integrated drive electronics (IDE) 105 within the processor chip 100 provide a hardware interface between the optical disk drive 300 and other internal components of the processor chip 100. In one embodiment, the IDE 105 may be programmable to enable the processor chip 100 to obtain data from a variety of different optical disk formats. The processor chip 100 of the embodiment shown in FIG. 1 also has a demultiplexer (DEMUX) 110 to segregate incoming video data from incoming audio data and, in the case of pure audio or pure video data, to direct the incoming data to the respective audio or video buffer. Such a processor chip 100 further includes buffers 115, 120 for the incoming audio data and video data, respectively. In one embodiment, the audio data buffer 115 and video data buffer 120 are each a first-in-first-out (FIFO) type of buffer.

The processor chip 100 depicted in FIG. 2 may have two primary processors: (1) a vector operation engine 125 implemented, for example, as a single instruction, multiple data (SIMD) microprocessor; and (2) a chip controller 135 implemented, for example, as a MIPS-X microcontroller. The vector operation engine 125 of one embodiment may perform parallel processing for decoding audio and video data files, some or all of which may be compressed. In such an embodiment, the vector operation engine 125 may have four or more multipliers in parallel to allow rapid data processing such as decoding and decompression of video and audio data files. The chip controller 135, including navigation software 137 running thereon, may perform a number of functions including managing the entry of data into the processor chip 100, controlling the movement of data within the processor chip 100, managing the decoding of data files (including interleaving decoding of video data files and audio data files), managing the decompression of data files, creating an association between still images stored in video data files and audio tracks stored in audio data files, and generating outputs for use in presenting an electronic slide show with audio. In one embodiment, such a chip controller 135 may be a 32-bit reduced instruction set computer (RISC) with a 16 kilobyte on-chip instruction cache. In another embodiment, the chip controller 135 may be implemented as a RISC without any embedded memory.

With further reference to FIG. 2, the processor chip 100 of one embodiment may include a data bus 130 in communication with a number of components including the FIFO audio buffer 115, the FIFO video buffer 120, the vector operation engine 125, the chip controller 135, a DRAM controller 140, a bit engine 145, a display module 150 and an audio output port 155. The vector operation engine 125, the bit engine 145, the display module 150 and the audio output port 155 may each have a direct memory access (DMA) channel to allow communication directly with the DRAM 500 over the data bus 130 without requiring the data to pass through the chip controller 135 each time it is transmitted within the processor chip 100.

The DRAM controller 140 of one embodiment is in communication with the DRAM 500, and may be a circuit for managing the reading and writing of data files to and from the DRAM 500. The bit engine 145 of one embodiment may selectively write 32-bit values to a register 147 and also may have a DMA channel. The bit engine 145 allows retrieval of an arbitrary amount of data from the DRAM 500 before such data is sent to the vector operation engine 125 for decoding. In one embodiment, the bit engine 140 may perform data masking functions when necessary. After decoding, data may be output from the processor chip 100 for presentation, or may be returned to the DRAM 500 for storage. Decoded video data may be output to the NTSC/PAL encoder 600 as YUV pixels. Decoded audio data may be output to the audio DAC 30 as pulse code modulated (PCM) samples.

In one embodiment, the chip controller 135 also manages the display module 150. The display module 150 allows the chip controller 135 to display an information screen 650 or other characters (e.g., a menu of commands and a display of available video and data files) on a display device such as the TV 20. The display module 150 may synchronize with the video signal source (in this case, the video output signal) to produce text, characters and/or graphics superimposed on a displayed video image. In one embodiment, the display module 150 may be compatible with a video signal encoder that is in turn compatible with both the National Television System Committee (NTSC) and Phase Alternating Line (PAL) television standards. In one embodiment the chip controller 135 may direct the SDRAM 500 to continuously send data representing a still image through the display module 150 (such that the still image is displayed for a period of time).

The audio output port 155 may be configured to accept stereo or multi-channel PCM data decoded from any of a number of digital audio formats (including, e.g., CD-DA, linear PCM, Dolby® Digital (AC-3), Dolby® ProLogic, DTS®, HDCD, MP3 and DVD Audio), and output such data in a form that is appropriate for the audio DAC 30.

In one embodiment, the ROM 200 may be an 8/16-bit erasable programmable ROM (EPROM) 200. The drive 300 of one embodiment may be an optical disk drive configured to read one or more of the following optical disk formats: compact disk read only memory (CD-ROM), compact disk digital audio (CD-DA), recordable compact disk (CD-R), rewriteable compact disk (CD-RW), video compact disk (VCD), super video compact disk (SVCD), digital versatile disk read only memory (DVD-ROM), recordable digital versatile disk (DVD−R) (DVD+R), rewriteable digital versatile disk (DVD−RW) (DVD+RW), digital versatile disk random access memory (DVD-RAM), digital versatile disk video format (DVD-Video), digital versatile disk audio format (DVD-Audio) and digital versatile disk video recording (DVD-VR).

One embodiment of the present invention may also include an auxiliary memory reader 400 that may be compatible with a portable storage medium (e.g., Memory Stick device, Compact Flash™ device, Microdrive™ device, Smart Media device, MultiMediaCard device, Secure Digital device or other equivalent medium or device) and a hard disk drive 450. Such an embodiment is depicted in FIGS. 1 and 2. Another embodiment of the present invention may include one or more memory readers that are not a drive 300, and may have no drive 300 at all.

The DRAM 500 of one embodiment may be a synchronous DRAM (SDRAM) having a number of audio data buffers 505-1 to 505-N and a number of video data buffers 510-1 to 510-N. Such an SDRAM 500 may have, for example, four megabytes of storage (4 MB).

In accordance with one embodiment, the video signal encoder 600 may be an NTSC/PAL encoder. In such an embodiment, the video signal encoder 600 may be configured to generate an analog composite video signal (i.e., transmission of video signals to TV 20 over a single wire), a super video (S-video) analog signal, (i.e., transmission of video signals by dividing the information into a signal for color, called chrominance, and a signal for brightness, called luminance) and a component video output. One example of a video signal encoder 600 may include three 9-bit digital-to-analog converters (DACs). In such an embodiment, one video DAC may generate composite video output, while the other two generate the S-video outputs.

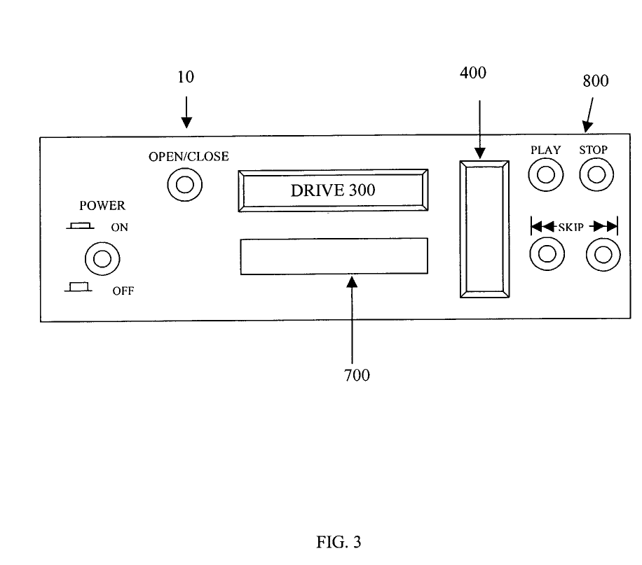

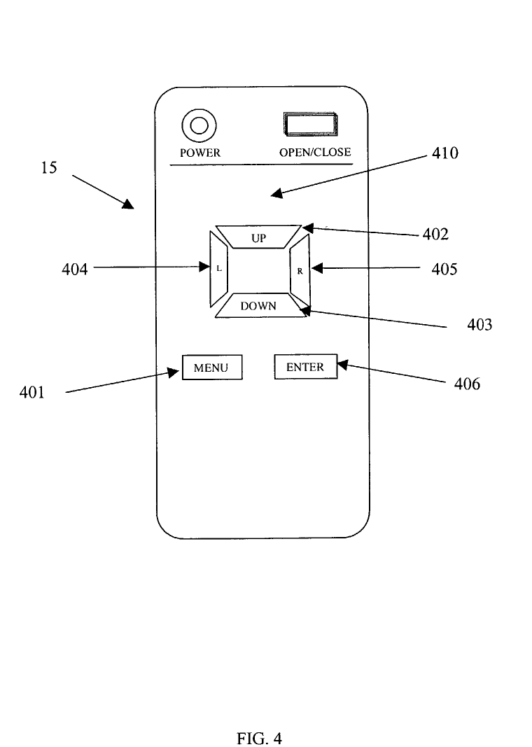

FIG. 3 depicts a front view of an optical disk player 10, including its user interface 800. FIG. 4 depicts one type of remote control device 15 according to an embodiment of the present invention. Such a remote control device 15 may include a number of buttons such as power on/off, display menu, select, move cursor right, move cursor left, move cursor up and move cursor down. The remote control device 15 may send commands to the optical disk player 10 by transmitting an infrared signal to a remote control sensor 700 in the player 10. In such an embodiment, the remote control sensor 700 may be an infrared signal receiver.

An alternative embodiment of a remote control device 15 may include a keyboard with a pointer/selector device (e.g., mouse, trackball, pointing stick or touch pad), game controller with a joystick and control buttons, or other like device. Both the remote control device 15 and user interface 800 may be used to power on/off the optical disk player 10, and to control functions of the optical disk player 10 as described below. For example, a user 1 may interact with the remote control device 15 to view a listing or menu of video and audio data files available for use in an electronic slide show presentation, to select files to be included in the slide show (e.g., selection of playlist of audio tracks or a playlist of still images), to select the manner of presentation of video files (e.g., selection of a mode for presentation and playback of still images and audio tracks), to create an association between one or more audio tracks and one or more still images, to select the duration of display for each still image, and to perform other slide show configuration functions.

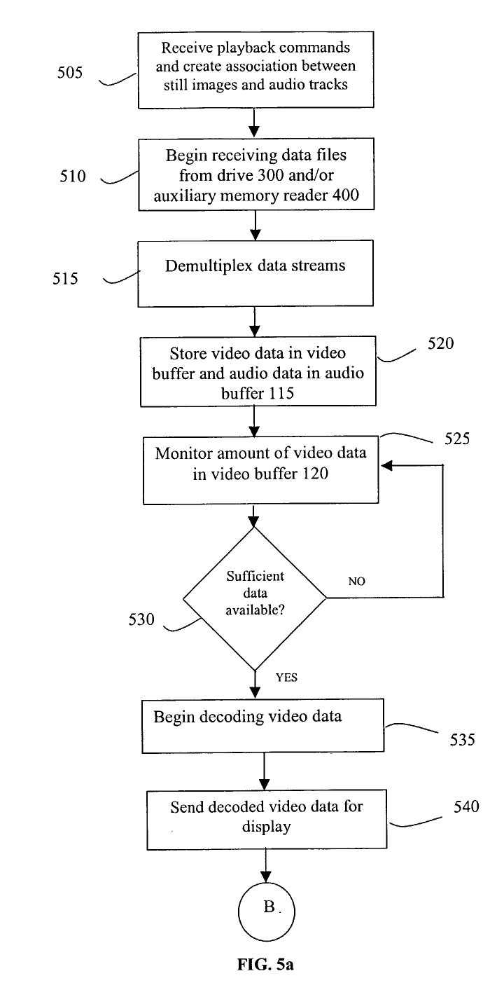

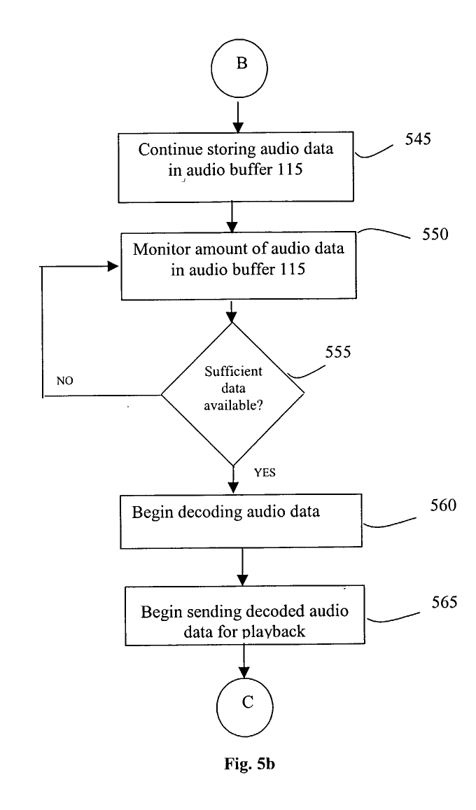

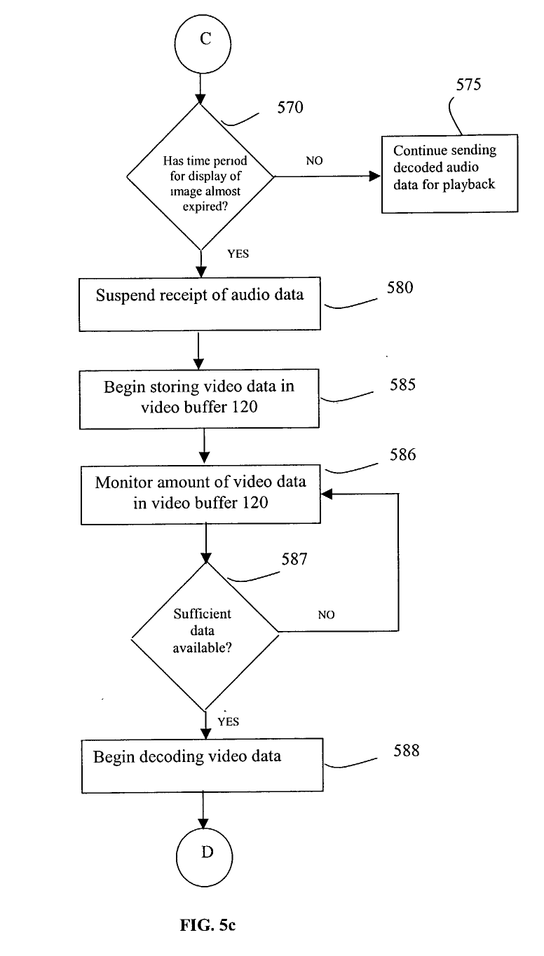

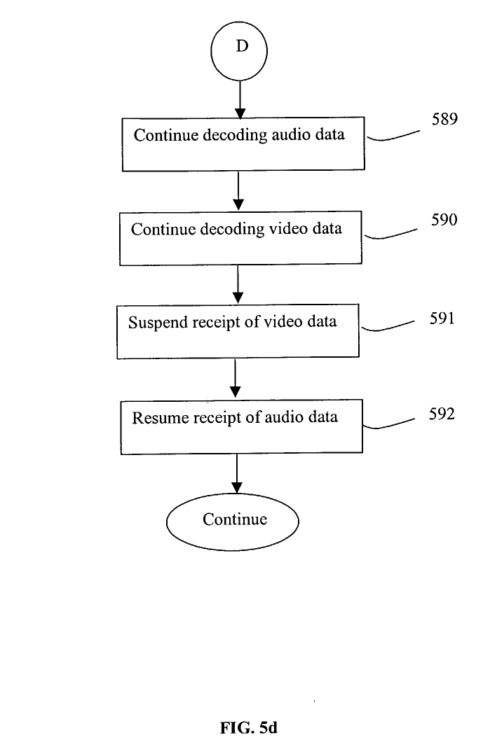

Various embodiments of methods in accordance with the present invention will now be described with continuing reference to FIGS. 1-4, and particular reference to FIGS. 5a-8.

II. Method Embodiments of the Invention

Data representing still video images (e.g., photographs, pictures, presentation slides and the like) and audio signals (e.g., songs, music or other sounds) may be stored in a variety of memory formats and in one or more types of memory media. For example, an optical disk 5 or flash memory device may contain a number of video data file 6 with compressed image data stored in a JPEG (Joint Photographic Experts Group) format or an MPEG (Moving Picture Experts Group) format and an audio data file 6 with compressed audio signal data stored in an MPEG Audio Layer III (i.e., file extension .mp3) format or a Windows Media Audio (i.e., file extension .wma) format.

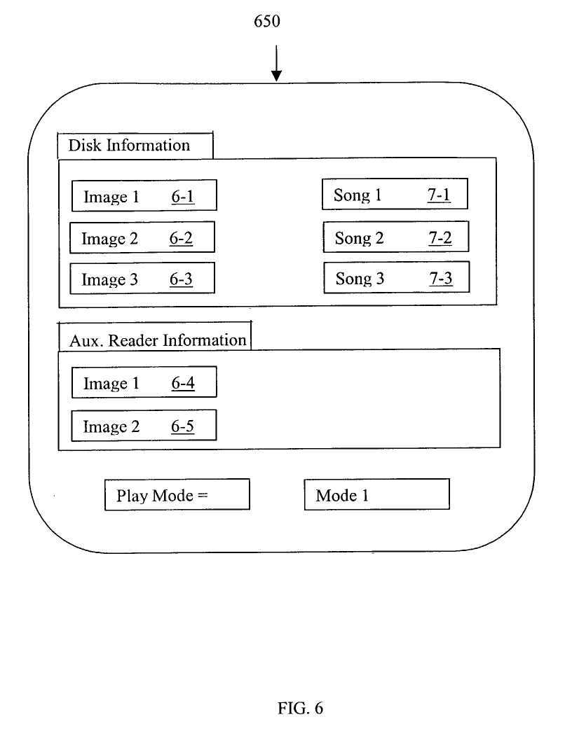

FIGS. 5a-5d illustrate certain operations performed in one embodiment of a method of presenting a still image slide show with audio. In such a method embodiment, the processor chip 100 may receive commands from a user 1 (as shown in step 505) via either the remote control device 15, the user interface 800, or both. Once an optical disk 5, flash memory device, or other memory medium containing still image video files 6 (in turn containing still image data) and/or audio files 7 has been loaded into the drive 300 and/or auxiliary memory reader 400, and has been detected by the optical disk player 10, the processor chip 100 may cause an information screen 650 (as shown, e.g., in FIG. 6) to be displayed automatically on a TV 20 for viewing by a user 1. In an alternative embodiment, the processor chip 100 may cause the information screen 650 to be displayed only upon command, such as the user 1 selecting the “menu” key 401 of the remote control device 15. The information screen 650 may contain a listing of the video files 6-1 to 6-N contained in the optical disk 5, flash memory device, hard disk or other memory medium, and any folders in which such video files 6 may have been stored, as well as the audio files 7-1 to 7-N contained on such inserted or otherwise activated memory media. Alternative embodiments of the processor chip 100 of the present invention may display the hierarchical file structure of a particular optical disk 5 of other memory medium reader(s) to the user 1 in different ways. In one such alternative example, the files and folders may be displayed in a linearized fashion such that a list of all files in the file system are shown with no folders. In another example embodiment, a file system with only one level of directories may be displayed (i.e., subdirectories eliminated by promoting them to the root level).

A user 1 may select a playback and presentation mode from a number of offered modes in order to play both the audio tracks stored in audio files and the still images stored in video files. In such an embodiment, the processor chip 100 may create in real time an association between still images and audio tracks that otherwise have not been associated or otherwise linked with one another beforehand (step 505). The processor chip 100 may then generate a slide show presentation for display on the TV 20. For example, one mode may present the contents of video files 6-1 to 6-N one by one (and each for a predetermined period of time, e.g., 30 seconds) in order beginning with the first or a selected video file 6, and during this time, each audio file 7-1 to 7-N may be played one by one in order beginning with the first or a selected audio file 7. In another mode, a user 1 may select one and only one audio file 7 to be played while the video files 6-1 to 6-N are presented in order starting from the first or a selected video file 6-1, thereby creating in real time another type of association between still images and an audio track. In a further mode, a user 1 may select a playlist of audio files 7-1 to 7-N to be played while the video files 6-1 to 6-N are presented in order starting from the first or a selected video file 6-1. Yet another mode may present a playlist of video files 6-1 to 6-N in order while a playlist of audio files 7-1 to 7-N are played in order. A selected image playlist may be a subset of the total of the available video files 6-1 to 6-N, and a selected audio playlist may be a subset of the total of the available audio files 7-1 to 7-N. Still another mode may present all the video files in a random order starting from a randomly selected file or a file selected by the user 1, while the processor chip 100 may automatically select one or more audio files 7 for playback. In yet another mode, a user 1 may specify a one-to-one correspondence between video and audio files using a simple menu interface (e.g., a keypad 410 of a remote control device 15). Using keys (e.g., “menu” key 401, “up cursor” key 402, “down cursor” key 403, “left cursor” key 404, “right cursor” key 405, “enter” key 406) on the keypad 410 of a remote control device 15, the user 1 may navigate the information screen 650 using the cursor keys 402, 403, 404, 405, and select a subset of files (or a folder containing certain files) to be played by pressing the “enter” key 406 while a particular file is highlighted. In such a mode, only the video files in the selected folder may be played (i.e., only the images in the folder are played). Once all of the images in the folder have been played, the information screen 650 may reappear. In yet another mode, the contents of each audio file 7-1 to 7-N may be played in order beginning with the first or a selected audio file, and the still image contents of different video file may be presented with each new audio track.

Further modes may be available if the user 1 has not selected either an audio file or a video file. In such a case, the processor chip 100 may automatically select, e.g., one of the playback and presentation modes described above as a default. In accordance with one embodiment, a slide show presentation may start automatically upon detection of an optical disk 5 (e.g., Kodak Picture CD) by the optical disk player 10, and play each video file and each audio file in a predetermined sequence with a predetermined association between audio and video files.

As shown in particular at step 510, the processor chip 100 may begin receiving video data files 6 and audio data files 7 from a memory medium reader including one or more of the following types of devices: an optical disk drive 300, an auxiliary memory reader 400 and a hard disk drive 450. For example, such data may be obtained from an optical disk 5 as one or more video data files 6 and one or more audio data files 7. In another example, video and audio data may be obtained from both an optical disk 5 and a memory medium compatible with the auxiliary memory reader 400. For example, still video image data for use in a slide show presentation may have been captured in a digital form using a digital camera and then stored on a memory medium such as a Memory Stick device, Compact Flash™ device, Smart Media device, Secure Digital device, Microdrive™ device, MultiMediaCard device, or other equivalent medium or device. Audio data for use in generating background sounds for the slide show may have been stored in digital form on a prefabricated CD, or a user 1 or other may have accessed a personal computer to store audio files on a CD-R or CD-RW. In one example method of operation, the processor chip 100 may obtain video data files 6 from the auxiliary memory reader 400, and audio data files 7 from the drive 300. Once an optical disk 5 containing video files 6 and/or audio files 7 has been loaded into the drive 300, raw data read from an optical disk drive 300 may enter the processor chip 100 through the IDE 105. Data leaving the IDE 105 and the auxiliary memory reader 400 may be, for example, streams of data that are audio and video multiplexed (i.e., stream contains both audio data and video data interspersed with one another).

As shown in steps 515 and 520, streams of data then may be passed through a demultiplexer (DEMUX) 110, which separates video data from audio data and sends the video data into a video data buffer 120 and the audio data into an audio data buffer 115. The audio data buffer 115 and video data buffer 120 may enable devices on the data bus 130 to perform bus arbitration when more than one device is competing for the same data at the same time.

In one example method of operation, the contents of an entire video data file 6 need not be read before decoding may begin. In accordance with such an example method, the processor chip 100 may monitor the amount of data in the video buffer 120 (as shown in step 525) and may begin decoding a video data file 6 once a sufficient amount of data from the video data file 6 has been transferred into the video data buffer 120 (as shown in steps 530 and 535). For example, decoding may begin once a slice of data is available in the video data buffer 120. While such a slice is being decoded, data may continue to be read from the video data file 6 into the video data buffer 120. When decoding of one slice is finished, the processor chip 100 may again examine the video data buffer 120 to determine if a sufficient amount of data exists in the video data buffer 120 for decoding of the next slice. If so, the next slice may be decoded. If not, the processor chip 100 may wait until there is enough data in the video data buffer 120 to continue decoding. By decoding one slice at a time, the process of reading data from the video data file 6 and the process of decoding such data may overlap to some extent to reduce the amount of time required to process the image data. As shown in step 540, once the contents of the video data file 6 are decoded, the video data (e.g., photograph) may be sent to the TV 20 for display.

Once a first image of a slide show has been decoded and displayed, a first audio data file 7-1 may be processed. In one example method of decoding compressed audio files 7, the contents of the entire audio data file 7 need not be read before the processor chip 100 may begin to generate signals for audible sounds to be played. In accordance with such an embodiment, the processor chip 100 may begin decoding an audio data file 7 once a sufficient amount of data from the audio data file 7 has been transferred into the audio data buffer 115 (as shown in steps 545-555). For example, decoding may begin once a few hundred audio samples of data are available in the audio data buffer 115 (as shown in step 560). While such samples are being decoded, data may continue to be read from the audio data file 7 into the audio data buffer 115. When decoding of the samples is finished, the processor chip 100 may again examine the audio data buffer 115 to determine if a sufficient amount of data exists in the audio data buffer 115 for decoding the next samples. If so, the next samples may be decoded. If not, the processor chip 100 may wait until there is enough data in the audio data buffer 115 to continue decoding. By decoding a small number of samples at a time, the process of reading data from the audio data file 6 and the process of decoding such data may overlap, thereby avoiding the need to have a large memory buffer capable of storing the entire audio data file to ensure continuous, uninterrupted audio presentation. As shown in step 565, once at least a portion of the contents of the audio data file 7 are decoded, the audio data (e.g., a song) may be sent to the DAC 30 for playback through the speakers 40.

According to one method embodiment, during reading and decoding of the audio data file 7, the process chip 100 may monitor the length of time a particular image has been displayed (shown in step 570 and 575). As described above, the processor chip 100 may be directed by a user 1 or otherwise configured by default to enable each image of a slide show presentation to be displayed for only a pre-selected amount of time. When the pre-selected display time for a particular image has almost expired, the processor chip 100 may begin to receive and decode the next video data file 6-2. In one embodiment, the receipt of audio data may be temporarily suspended and, during such a time, the processor chip 100 may alternate between decoding of audio data and decoding of video data (as shown in steps 588-590), provided sufficient audio data exists in the audio data buffer 115 such that no audio data underflow condition will occur during the time the processor chip 100 is receiving video data corresponding to a new image of the slide show presentation. The processor chip 100 of one embodiment may alternate between the reading of audio data and the reading of video data (steps 591 and 592). Such a process may continue and repeat as further video and audio files are processed.

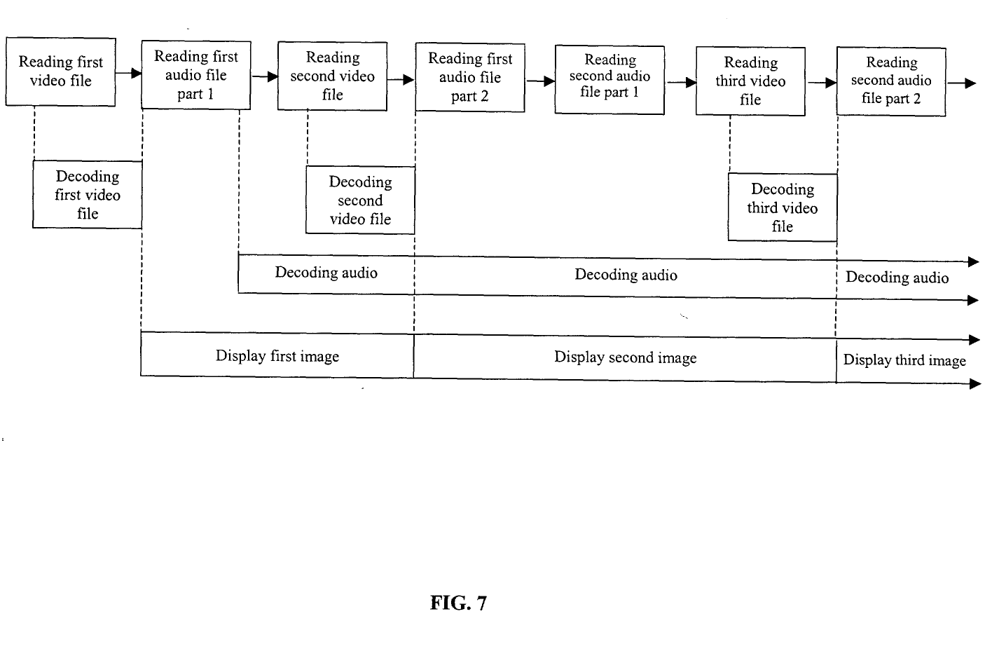

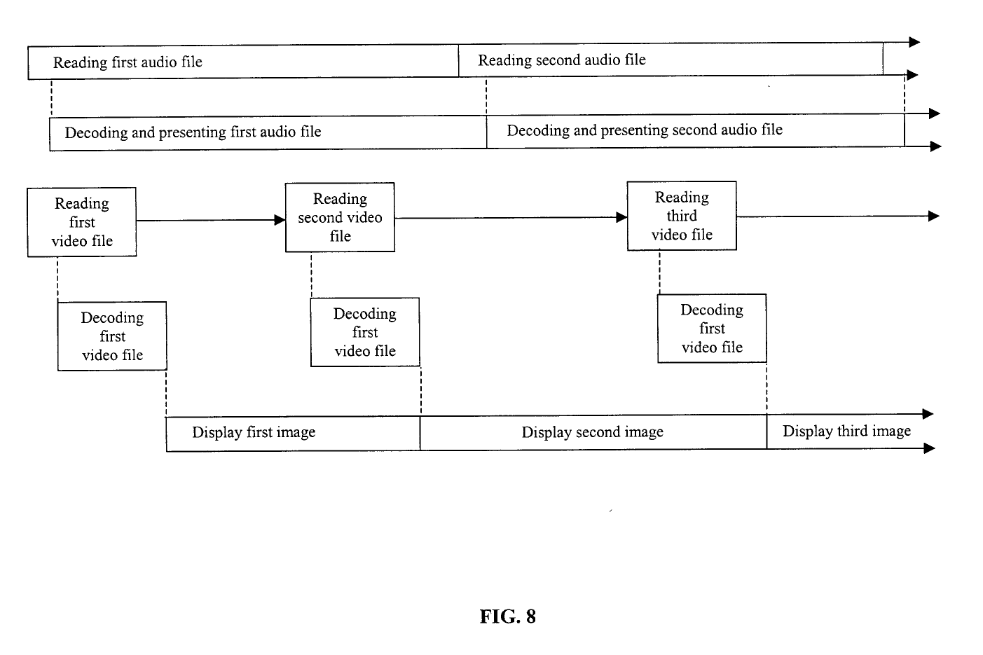

FIGS. 7 and 8 illustrate examples of video data and audio data reading, decoding and presenting sequences according to embodiments of the present invention. As shown in FIG. 7, a video file may be read in its entirety before an audio file is read. Similarly, once reading of an audio file begins, such reading of the audio file may continue until the entirety of the audio file has been read. Such a sequencing, however, may in some cases result in an audio data underflow condition wherein there is insufficient audio data read into the audio data buffer to allow decoding and playback to commence or continue. As represented by FIG. 8, the reading of audio data files and the reading of video data files may be interleaved such that the entirety of the video file need not be read into the video data buffer before reading of the audio data file may begin or continue. In such a sequence, a portion of a video data file may be read, then a portion of an audio data file may be read, and this process may continue with great frequency to avoid an audio underflow condition.

In connection with an alternative embodiment of a processor chip which has separate processors for audio data and video data, such interleaving of the reading and/or decoding of audio data and video data may not be necessary.

Although illustrative embodiments and example methods have been shown and described herein in detail, it should be noted and will be appreciated by those skilled in the art that there may be numerous variations and other embodiments which may be equivalent to those explicitly shown and described. For example, the scope of the present invention may not necessarily be limited in all cases to execution of the aforementioned steps in the order discussed. Unless otherwise specifically stated, the terms and expressions have been used herein as terms and expressions of description, not of limitation. Accordingly, the invention is not limited by the specific illustrated and described embodiments and examples (or terms or expressions used to describe them) but only by the scope of the appended claims.

We claim:

1. An apparatus, comprising:
a memory medium reader configured to read an audio data file and a video data file, wherein said audio data file contains data descriptive of an audio track and said video data file contains data descriptive of a still image; and
a processor circuit configured to:
decode said audio data file and said video data file;
create in real time an association between said still image and said audio track; and
generate a slide show comprising said still image and said audio track.

2. The apparatus of claim 1, wherein said processor circuit comprises an integrated circuit chip.

3. The apparatus of claim 2, wherein said integrated circuit chip does not comprise a general purpose processor.

4. The apparatus of claim 1, wherein said audio data file comprises a compressed data file format.

5. The apparatus of claim 1, wherein said video data file comprises a compressed data file format.

6. The apparatus of claim 1, wherein said memory medium reader comprises an optical disk drive.

7. The apparatus of claim 6, wherein said optical disk drive comprises a DVD drive.

8. The apparatus of claim 1, wherein said memory medium reader comprises a hard disk drive.

9. The apparatus of claim 1, wherein said memory medium reader comprises a reader configured to read a type of portable memory medium.

10. The apparatus of claim 9, wherein said portable memory medium comprises a type of flash memory device.

11. The apparatus of claim 1, wherein said memory medium reader comprises a first reader and a second reader, wherein said audio data file and said video data file are obtained from one or both of said first reader and said second reader.

12. The apparatus of claim 11, wherein said first reader comprises a DVD drive and said second reader comprises a hard disk drive.

13. The apparatus of claim 11, wherein said first reader comprises a DVD drive and said second reader comprises a device configured to read a type of portable memory medium.

14. The apparatus of claim 13, wherein said portable memory medium comprises a type of flash memory device.

15. The apparatus of claim 11, wherein said first reader comprises a hard disk drive and said second reader comprises a device configured to read a type of portable memory medium.

16. The apparatus of claim 15, wherein said portable memory medium comprises a type of flash memory device.

17. The apparatus of claim 6, wherein said optical disk drive is adapted to read an optical disk format from a group of formats consisting of compact disk read only memory (CD-ROM), compact disk digital audio (CD-DA), recordable compact disk (CDR), rewriteable compact disk (CD-RW), video compact disk (VCD), super video compact disk (SVCD), digital versatile disk read only memory (DVD-ROM), recordable digital versatile disk (DVD−R) (DVD+R), rewriteable digital versatile disk (DVD−RW) (DVD+RW), digital versatile disk random access memory (DVD-RAM), digital versatile disk video format (DVD-Video), digital versatile disk audio format (DVD-Audio) and digital versatile disk video recording (DVD-VR).

18. The apparatus of claim 1, wherein said processor circuit is further configured to interleave decoding of said audio data file with decoding of said video data file.

19. The apparatus of claim 1, wherein said audio track is one of a plurality of audio tracks recorded in one or more audio data files and said still image is one of a plurality of still images recorded in one or more video data files, and wherein said association comprises a mode wherein each of said still images is displayed for a predetermined amount of time and each of said audio tracks is played in order during display of said still images.

20. The apparatus of claim 1, wherein said audio track is one of a plurality of audio tracks recorded in one or more audio data files and said still image is one of a plurality of still images recorded in one or more video data files, and wherein said association comprises a mode wherein each of said still images is displayed for a predetermined amount of time and a selected audio track is played during display of one or more of said still images.

21. The apparatus of claim 1, wherein said audio track is one of a plurality of audio tracks recorded in one or more audio data files and said still image is one of a plurality of still images recorded in one or more video data files, and wherein said association comprises a mode wherein each of said still images is displayed for a predetermined amount of time and a selected playlist comprising a subset of said audio tracks is played in order during display of said still images.

22. The apparatus of claim 1, wherein said audio track is one of a plurality of audio tracks recorded in one or more audio data files and said still image is one of a plurality of still images recorded in one or more video data files, and wherein said association comprises a mode wherein a selected image playlist comprising a subset of said still images is displayed each for a predetermined amount of time, and a selected audio playlist comprising a subset of said audio tracks is played in order during display of said still images.

23. The apparatus of claim 1, wherein said audio track is one of a plurality of audio tracks recorded in one or more audio data files and said still image is one of a plurality of still images recorded in one or more video data files, and wherein said association comprises a mode wherein a first selected audio track is played with a first still image and a second selected audio track is played with a second still image.

24. The apparatus of claim 1, wherein said audio track is one of a plurality of audio tracks recorded in one or more audio data files and said still image is one of a plurality of still images recorded in one or more video data files, and wherein said association comprises a mode wherein each of said audio tracks is played in order, and a new still image is displayed during playback of each of said audio tracks.

25. The apparatus of claim 1, wherein processor circuit comprises a reduced instruction set computer processor.

26. The apparatus of claim 1, further comprising a remote control device configured to send a command to said processor circuit to select said association between said image and said audio track.

27. A digital versatile disk (DVD) player comprising an integrated circuit chip configured to generate a still image slide show with an audio track.

28. The DVD player of claim 27, further comprising a memory medium reader configured to read an audio data file and a video data file recorded on a memory medium.

29. The DVD player of claim 28, wherein said memory medium reader comprises an optical disk drive.

30. The DVD player of claim 29, wherein said optical disk drive comprises a DVD drive.

31. The DVD player of claim 28, wherein said memory medium reader comprises a hard disk drive.

32. The DVD player of claim 28, wherein said memory medium reader comprises a reader configured to read a type of portable memory medium.

33. The DVD player of claim 32, wherein said portable memory medium comprises a type of flash memory device.

34. The DVD player of claim 28, further comprising an additional memory medium reader, wherein said audio data file and said video data file are obtained from one or both of said memory medium reader and said additional memory medium reader.

35. The DVD player of claim 34, wherein said memory medium reader comprises a DVD drive and said additional memory medium reader comprises a hard disk drive.

36. The DVD player of claim 34, wherein said memory medium reader comprises a DVD drive and said additional memory medium reader comprises a reader configured to read a type of portable memory medium.

37. The DVD player of claim 36, wherein said portable memory medium comprises a type of flash memory device.

38. The DVD player of claim 34, wherein said memory medium reader comprises a hard disk drive and said additional memory medium reader comprises a reader configured to read a type of portable memory medium.

39. The DVD player of claim 38, wherein said portable memory medium comprises a type of flash memory device.

40. The DVD player of claim 28, wherein said audio data file comprises a compressed data file format.

41. The DVD player of claim 28, wherein said video data file comprises a compressed data file format.

42. The DVD player of claim 28, wherein said memory medium reader is adapted to read an optical disk format from a group of formats consisting of compact disk read only memory (CD-ROM), compact disk digital audio (CD-DA), recordable compact disk (CD-R), rewriteable compact disk (CD-RW), video compact disk (VCD), super video compact disk (SVCD), digital versatile disk read only memory (DVD-ROM), recordable digital versatile disk (DVD−R) (DVD+R), rewriteable digital versatile disk (DVD−RW) (DVD+RW), digital versatile disk random access memory (DVD-RAM), digital versatile disk video format (DVD-Video), digital versatile disk audio format (DVD-Audio) and digital versatile disk video recording (DVD-VR).

43. The DVD player of claim 27, wherein said integrated circuit chip does not comprise a general purpose processor.

44. The DVD player of claim 27, wherein said integrated circuit chip is further configured to decode an audio data file and a video data file, wherein said audio data file contains an audio track and said video data file contains a still image.

45. The DVD player of claim 44, wherein said integrated circuit chip is further configured to interleave decoding of said audio data file with decoding of said video data file.

46. The DVD player of claim 44, wherein said integrated circuit chip is further configured to decompress said audio data and said video data.

47. The DVD player of claim 27, wherein said slide show comprises a still image, and said integrated circuit chip is further configured to create in real time an association between said still image and said audio track.

48. The DVD player of claim 47, wherein said audio track is one of a plurality of audio tracks and said slide show comprises a plurality of still images, and wherein said association comprises a mode wherein each of said still images is displayed for a predetermined amount of time and each of said audio tracks is played in order during display of said still images.

49. The DVD player of claim 40, wherein said audio track is one of a plurality of audio tracks and said slide show comprises a plurality of still images, and wherein said association comprises a mode wherein each of said still images is displayed for a predetermined amount of time and a selected audio track is played during display of one or more of said still images.

50. The DVD player of claim 40, wherein said audio track is one of a plurality of audio tracks and said slide show comprises a plurality of still images, and wherein said association comprises a mode wherein each of said still images is displayed for a predetermined amount of time, and a selected playlist comprising a subset of said audio tracks is played in order during display of said still images.

51. The DVD player of claim 40, wherein said audio track is one of a plurality of audio tracks and said slide show comprises a plurality of still images, and wherein said association comprises a mode wherein a selected image playlist comprising a subset of said still images is displayed each for a predetermined amount of time, and a selected audio playlist comprising a subset of said audio tracks is played in order during display of said still images.

52. The DVD player of claim 40, wherein said audio track is one of a plurality of audio tracks and said slide show comprises a plurality of still images, and wherein said association comprises a mode wherein a first selected audio track is played with a first still image and a second selected audio track is played with a second still image.

53. The DVD player of claim 40, wherein said audio track is one of a plurality of audio tracks and said slide show comprises a plurality of still images, and wherein said association comprises a mode wherein each of said audio tracks is played in order, and a new still image is displayed during playback of each of said audio tracks.

54. A method, comprising:
decoding an audio data file and a video data file, wherein said audio data file contains data descriptive of an audio track and said video data file contains data descriptive of a still image;
creating in real time an association between said still image and said audio track; and
generating a slide show comprising said still image and said audio track.

55. The method of claim 54, wherein said audio data file comprises a compressed data file.

56. The method of claim 54, wherein said video data file comprises a compressed data file.

57. The method of claim 54, further comprising receiving said audio data file and said video data file from a memory medium reader.

58. The method of claim 57, wherein said memory medium reader comprises an optical disk drive.

59. The method of claim 58, wherein said optical disk drive comprises a DVD drive.

60. The method of claim 57, wherein said memory medium reader comprises a hard disk drive.

61. The method of claim 57, wherein said memory medium reader comprises a reader configured to read a type of portable memory medium.

62. The method of claim 61, wherein said portable memory medium comprises a type of flash memory device.

63. The method of claim 57, wherein said memory reader comprises a first reader and a second reader, wherein said audio data file and said video data file are received from one or both of said first reader and said second reader.

64. The method of claim 63, wherein said first reader comprises a DVD drive and said second reader comprises a hard disk drive.

65. The method of claim 63, wherein said first reader comprises a DVD drive and said second reader comprises a device configured to read a type of portable memory medium.

66. The method of claim 65, wherein said portable memory medium comprises a type of flash memory device.

67. The method of claim 63, wherein said first reader comprises a hard disk drive and said second reader comprises a device configured to read a type of portable memory medium.

68. The method of claim 67, wherein said portable memory medium comprises a type of flash memory device.

69. The method of claim 58, wherein said optical disk drive is adapted to read an optical disk format from a group of formats consisting of compact disk read only memory (CD-ROM), compact disk digital audio (CD-DA), recordable compact disk (CDR), rewriteable compact disk (CD-RW), video compact disk (VCD), super video compact disk (SVCD), digital versatile disk read only memory (DVD-ROM), recordable digital versatile disk (DVD−R) (DVD+R), rewriteable digital versatile disk (DVD−RW) (DVD+RW), digital versatile disk random access memory (DVD-RAM), digital versatile disk video format (DVD-Video), digital versatile disk audio format (DVD-Audio) and digital versatile disk video recording (DVD-VR).

70. The method of claim 54, further comprising interleaving decoding of said audio data file with decoding of said video data file.

71. The method of claim 54, wherein said audio track is one of a plurality of audio tracks recorded in one or more audio data files and said still image is one of a plurality of still images recorded in one or more video data files, and wherein said association comprises a mode wherein each of said still images is displayed for a predetermined amount of time and each of said audio tracks is played in order during display of said still images.

72. The method of claim 54, wherein said audio track is one of a plurality of audio tracks recorded in one or more audio data files and said still image is one of a plurality of still images recorded in one or more video data files, and wherein said association comprises a mode wherein each of said still images is displayed for a predetermined amount of time and a selected audio track is played during display of one or more of said still images.

73. The method of claim 54, wherein said audio track is one of a plurality of audio tracks recorded in one or more audio data files and said still image is one of a plurality of still images recorded in one or more video data files, and wherein said association comprises a mode wherein each of said still images is displayed for a predetermined amount of time, and a selected playlist comprising a subset of said audio tracks is played in order during display of said still images.

74. The method of claim 54, wherein said audio track is one of a plurality of audio tracks recorded in one or more audio data files and said still image is one of a plurality of still images recorded in one or more video data files, and wherein said association comprises a mode wherein a selected image playlist comprising a subset of said still images is displayed each for a predetermined amount of time, and a selected audio playlist comprising a subset of said audio tracks is played in order during display of said still images.

75. The method of claim 54, wherein said audio track is one of a plurality of audio tracks recorded in one or more audio data files and said still image is one of a plurality of still images recorded in one or more video data files, and wherein said association comprises a mode wherein a first selected audio track is played with a first still image and a second selected audio track is played with a second still image.

76. The method of claim 54, wherein said audio track is one of a plurality of audio tracks recorded in one or more audio data files and said still image is one of a plurality of still images recorded in one or more video data files, and wherein said association comprises a mode wherein each of said audio tracks is played in order, and a new still image is displayed during playback of each of said audio tracks.

77. A system, comprising:
means for decoding an audio data file and a video data file, wherein said audio data file contains data descriptive of an audio track and said video data file contains data descriptive of a still image;
means for creating in real time an association between said still image and said audio track; and
means for generating a slide show comprising said still image and said audio track.
